(19) United States
(12) Patent Application Publication
(10) Pub. No.: US 2025/0244008 A1
(43) Pub. Date: Jul. 31, 2025

(54) NO MORE DARKNESS

(71) Applicant: Antonio Chambers, Lasvegas, NV (US)

(72) Inventor: Antonio Chambers, Lasvegas, NV (US)

(21) Appl. No.: 18/831,325

(22) Filed: Nov. 15, 2024

Related U.S. Application Data
(60) Provisional application No. 63/629,662, filed on Nov. 16, 2023.

(51) Int. Cl. F21V 33/00; A45C 15/06; A45F 3/00; A45F 3/04; F21Y 115/10

(52) U.S. Cl. CPC F21V 33/0004; A45C 15/06; A45F 3/04; A45F 2003/003; F21Y 2115/10

(57) ABSTRACT

No More Darkness is a new changing idea so that people carry these products: Briefcases, Backpacks, Bookbags, Luggage, and Purses. These items are highly used by majority of Americans on a daily basis in some form or fashion. So, I thought of an idea to make looking in these products mentioned above more convenient and safer, because you now have light in your products mentioned above to be easily seen. What you are looking for which will lesson injuries for your hands and fingers digging in these products looking for stuff. No More Darkness will enhance the quality of items listed above, using No More Darkness seeing things make it faster when using No More Darkness.

The invention No More Darkness was created for easy access to make things simple and convenient for the times that people use on a daily basis such as Purses, Briefcase, Backpack, Bookbag, and Luggage of all types of these items mention above that No More Darkness will supply to these items/products, so you can see what you are searching for with No More Darkness you don't have to search anymore because of the invention created to light up your product for easy findings. No More Darkness will enhance these products mentioned above.as I study the invention a long observation has led me to the conclusion that this idea will be used by a large number of people that used these products mentioned above with the addition of No More Darkness.

Also the idea can be added to the items mentioned above Purses, luggage, briefcases, backpacks, and bookbags using No More Darkness for your convenience. This addition to the items mentioned above will be no problem, you will bring in your product(s) Briefcases, Backpacks, Bookbags, Luggage, and Purses that you want to add No More Darkness and will enhance your products to give you light when you open them and will turn off when closed. No More Darkness uses batteries, wires, circuits and LED's to operate inside the products mentioned above.

No More Darkness can come in handy in case of a power outage. Just open your products mentioned above for your convenience. The invention No More Darkness is created to give people the use of these products mentioned above, on a daily basis will have light and can be installed in your products, mentioned above Purses, luggage, briefcases, backpacks, and bookbags.

No More Darkness can be used with backpacks, bookbags, briefcases, purses, and luggage of all sizes and material. The invention of No More Darkness is created to give people the light needed to use their products mentioned above to be able to see inside their products mentioned above by using No More Darkness.

### DRAWINGS FIGURE DESCRIPTION

Drawing 1: Briefcase

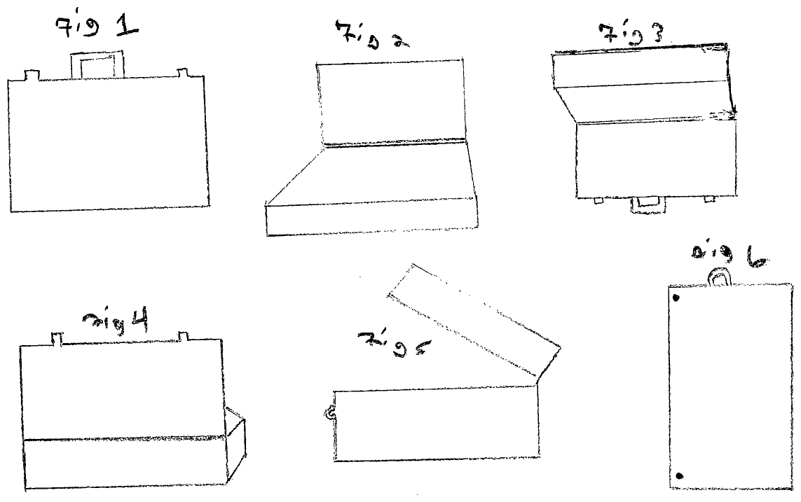

1. FIG. 1—Closed front view

2. FIG. 2—Open upwards front view

3. FIG. 3—Open downwards front view

4. FIG. 4—Open upwards back view

5. FIG. 5—Open side view

6. FIG. 6—Closed side view

Drawing 2: Backpack

1. FIG. 1—Backpack open front view

Drawing 3: Electrical Circuit

1. FIG. 1—Electric wires

2. FIG. 2—Power source

3. FIG. 3—Switch

4. FIG. 4—Consumer Bulb

1. A light source that uses an electric circuit, wires, batteries, and LED's to light your products backpacks, bookbags, briefcases, purses, and luggage.

2. Will function when opening and closing your product backpacks, bookbags, briefcases, purses, and luggage.
